(19) United States
(12) Patent Application Publication
(10) Pub. No.: US 2025/0347969 A1
(43) Pub. Date: Nov. 13, 2025

(54) MULTI-TRANSVERSE-MODE OPTICAL PROCESSOR

(71) Applicant: THE ROYAL INSTITUTION FOR THE ADVANCEMENT OF LEARNING/MCGILL UNIVERSITY, Montréal (CA)

(72) Inventors: Hassan RAHBARDAR MOJAVER, La Prairie (CA); Odile LIBOIRON-LADOUCEUR, Montreal (CA)

(21) Appl. No.: 18/867,098

(22) PCT Filed: May 19, 2023
(86) PCT No.: PCT/CA2023/050695

§ 371 Date: Nov. 19, 2024

Related U.S. Application Data
(60) Provisional application No. 63/344,174, filed on May 20, 2022.

(51) Int. Cl. G02F 1/21; G02F 1/225; G06E 3/00

(52) U.S. Cl. CPC G02F 1/212; G02F 1/225; G06E 3/005

(57) ABSTRACT

There is provided an optical processing unit comprising a first Mach-Zehnder interferometer (MZI) and a second MZI optically coupled to the first MZI, each of the first MZI and the second MZI having a first internal waveguide arm and a second internal waveguide arm configured to propagate optical modes therein, a first phase shifter optically coupled to the first internal waveguide arm of the first MZI and configured to impart a same first phase shift to the optical modes, a second phase shifter optically coupled to the first internal waveguide arm of the second MZI and configured to impart a same second phase shift to the optical modes, and a third phase shifter optically coupled to the second internal waveguide arm of the second MZI and configured to impart a third phase shift to the different optical modes, the third phase shift having a different value for each of the optical modes.

### CROSS-REFERENCE TO RELATED APPLICATIONS

The present application claims the benefit of U.S. Provisional Patent Application No. 63/344,174 filed on May 20, 2022, the contents of which are hereby incorporated by reference.

### FIELD

The improvements generally relate to the field of optoelectronic computing systems, and more particularly to programmable optical processors.

### BACKGROUND

Programmable optical processors may be used to achieve ultrafast and energy efficient optical computation. These processors can efficiently perform the vector-matrix multiplication portion of neural networks from the inherent parallelism present in optics, in contrast with sequential operations in electronics. Programmable optical processors can also pave the way for integrated microwave photonics (IMWP), realize multiply-accumulate (MAC) operation in computing, and be used in quantum computing. With deep learning facing fast-growing computational demand limiting its progress, energy efficient computational accelerators fabricated in silicon photonic (SiPh) technology are candidates to meet the computational demands of future machine learning and deep learning applications.

The programming techniques currently proposed for optical processors are mostly focused on in-situ training methods, where an optimization technique such as back propagation or gradient descent is used. These techniques require a considerable amount of computation for programming an individual chip. Ideally, after their fabrication, programmable optical processors should be fully reconfigurable by software similarly to electronics field-programmable gate arrays (FPGAs). One can perform ex-situ programming on an optical FPGA, i.e., a specific weight matrix can be implemented on different similar chips. However, programmable optical processors, unlike electronic FPGAs, are built on analogue building blocks more sensitive to the device parameters. Fabrication variations therefore translate into considerable computation error and accuracy in these processors, requiring the use of hardware error correction schemes. In addition, unlike in-situ training, ex-situ calibration and programming of optical processors require sensing both optical power and optical phase. Although sensing optical power is feasible in photonic integrated circuits using on-chip photodetectors, sensing optical phase requires complex and elaborate hardware.

Therefore, there is a need for improvement.

### SUMMARY

In accordance with one aspect, there is provided an optical processing unit comprising a first Mach-Zehnder interferometer (MZI) and a second MZI optically coupled to the first MZI, each of the first MZI and the second MZI having a first internal waveguide arm and a second internal waveguide arm configured to propagate optical modes therein, a first phase shifter optically coupled to the first internal waveguide arm of the first MZI and configured to impart a same first phase shift to the optical modes, a second phase shifter optically coupled to the first internal waveguide arm of the second MZI and configured to impart a same second phase shift to the optical modes and a third phase shifter optically coupled to the second internal waveguide arm of the second MZI and configured to impart a third phase shift to the optical modes, the third phase shift having a different value for each of the optical modes.

In some embodiments, the optical modes comprise a fundamental quasi-transverse electric (TE0) mode and a first quasi-transverse electric (TE1) mode.

In some embodiments, the first MZI has a first input waveguide arm optically coupled to a first input port and a second input waveguide arm optically coupled to a second input port, and a first optical wave having the optical modes is received via the first input port and the second input port.

In some embodiments, the first MZI has a first output waveguide arm and a second output waveguide arm, and the second MZI has a third input waveguide arm and a third output waveguide arm, the first output waveguide arm of the first MZI optically coupled to the third input waveguide arm of the second MZI, the second output waveguide arm of the first MZI optically coupled to a first output port, and the third output waveguide arm of the second MZI optically coupled to a second output port.

In some embodiments, the first MZI comprises a first beam splitter configured to split the first optical wave into second optical waves guided by the first internal waveguide arm and the second internal waveguide arm of the first MZI and a first beam combiner configured to combine the second optical waves into third optical waves guided by the first output waveguide arm and the second output waveguide arm of the first MZI.

In some embodiments, the second MZI comprises a second beam splitter configured to split one of the third optical waves guided by the first output waveguide arm into fourth optical waves guided by the first internal waveguide arm and the second internal waveguide arm of the second MZI and a second beam combiner configured to combine the fourth optical waves from the first internal waveguide arm and the second internal waveguide arm of the second MZI into a fifth optical wave guided by the output waveguide arm of the second MZI.

In some embodiments, each of the first beam splitter, the first beam combiner, the second beam splitter, and the second beam combiner is a multimode interferometer (MMI).

In some embodiments, each of the first beam splitter, the first beam combiner, the second beam splitter, and the second beam combiner is a directional coupler.

In some embodiments, output optical power having an amplitude and a phase is output via the first output port and the second output port, and the first phase shifter is configured to impart the first phase shift for controlling the amplitude of the optical power and the second phase shifter and the third phase shifter are respectively configured to impart the second phase shift and the third phase shift for controlling the phase of the optical power.

In some embodiments, each of the first phase shifter, the second phase shifter, and the third phase shifter is a thermo-optic phase shifter having a thermo-optic coefficient, and the thermo-optic coefficient of the first phase shifter and the second phase shifter is the same for all the optical modes, and the thermo-optic coefficient of the third phase shifter is different for each of the optical modes.

In accordance with one aspect, there is provided an optical processor system comprising an array of input optical waveguides configured to receive an optical input vector comprising a first plurality of optical signals, an array of output optical waveguides and a multi-transverse-mode optical processor interposed between the array of input optical waveguides and the array of output optical waveguides and in optical communication therewith for guiding the first plurality of optical signals towards the array of output optical waveguides, the optical processor comprising a plurality of interconnected optical processor building blocks. Each optical processor building block comprises a first Mach-Zehnder interferometer (MZI) and a second MZI optically coupled to the first MZI, each of the first MZI and the second MZI having a first internal waveguide arm and a second internal waveguide arm and configured to propagate optical modes therein, a first phase shifter optically coupled to the first internal waveguide arm of the first MZI and configured to impart a same first phase shift to the optical modes, a second phase shifter optically coupled to the first internal waveguide arm of the second MZI and configured to impart a same second phase shift to the optical modes and a third phase shifter optically coupled to the second internal waveguide arm of the second MZI and configured to impart a third phase shift to the optical modes, the third phase shift having a different value for each of the optical modes.

In some embodiments, the optical modes comprise a fundamental quasi-transverse electric (TE0) mode and a first quasi-transverse electric (TE1) mode.

In some embodiments, the optical processor system further comprises a phase calibration unit configured to apply a first bias voltage to the first phase shifter for causing the first phase shifter to impart the first phase shift to the optical modes, a second bias voltage to the second phase shifter for causing the second phase shifter to impart the second phase shift to the optical modes, and a third bias voltage to the third phase shifter for causing the third phase shifter to impart the third phase shift to the optical modes.

In some embodiments, the optical processor system further comprises a plurality of multiplexers each interconnecting input ports of the optical processor system to input waveguide arms of first selected ones of the plurality of interconnected optical processing units, and a plurality of de-multiplexers each interconnecting output ports of the optical processor system to output waveguide arms of second selected ones of the plurality of interconnected optical processing units.

In some embodiments, the phase calibration unit is configured to, for each of the plurality of interconnected optical processor building blocks (a) apply an electrical voltage to the first phase shifter to achieve a desired power level at an output of the optical processor, (b) set a voltage bias value of the second phase shifter to an initial value, (c) determine the voltage bias value of the third phase shifter that maximizes a TE0 power output at a first one of the output optical waveguides, (d) measure a TE1 power output at the first output optical waveguide and compute a given phase shift for the second phase shifter based on a thermo-optic coefficient for TE0 and TE1, (e) compare the computed phase shift to a desired phase shift value and (f) determine that the computed phase shift fails to match the desired phase shift value, change the voltage bias value of the second phase shifter, and repeat steps (c) to (e).

In some embodiments, for each optical processor building block, the first MZI has a first input waveguide arm optically coupled to a first input port and a second input waveguide arm optically coupled to a second input port, and a first optical wave having the optical modes is received via the first input port and the second input port.

In some embodiments, for each optical processor building block, the first MZI has a first output waveguide arm and a second output waveguide arm, and the second MZI has a third input waveguide arm and a third output waveguide arm, the first output waveguide arm of the first MZI optically coupled to the third input waveguide arm of the second MZI, the second output waveguide arm of the first MZI optically coupled to a first output port, and the third output waveguide arm of the second MZI optically coupled to a second output port.

In accordance with one aspect, there is provided a method for programming a multi-transverse-mode optical processor, the optical processor interposed between a plurality of input optical waveguides and a plurality of output optical waveguides, the method comprising (a) applying an electrical voltage to a first phase shifter of the optical processor to achieve a desired power level at an output of the optical processor, (b) setting a voltage bias value of a second phase shifter of the optical processor to an initial value, the second phase shifter configured to impart a same phase shift to different optical modes propagating through the optical processor, (c) determining the voltage bias value of a third phase shifter of the optical processor that maximizes a TE0 power output at a first one of the output optical waveguides, the third phase shifter configured to impart different phase shifts to the different optical modes propagating through the optical processor, (d) measuring a TE1 power output at the first output optical waveguide and compute a given phase shift for the second phase shifter based on a thermo-optic coefficient for TE0 and TE1, (e) comparing the computed phase shift to a desired phase shift value and (f) determining that the computed phase shift fails to match the desired phase shift value, changing the voltage bias value of the second phase shifter, and repeating steps (c) to (e).

In some embodiments, applying the electrical voltage to a first phase shifter comprises applying a plurality of Direct Current (DC) bias voltage values and measuring the TE0 power output at the first one of the output optical waveguides to determine whether the desired power level at the output of the optical processor has been achieved.

In some embodiments, the method for programming a multi-transverse-mode optical processor further comprises (g) storing a correlation between the DC bias voltage values, respective values of a first phase shift imparted by the first phase shifter upon application of the respective DC bias voltage values, and respective power levels output by the optical processor in response to application of the respective DC bias voltage values.

Many further features and combinations thereof concerning embodiments described herein will appear to those skilled in the art following a reading of the instant disclosure.

### DESCRIPTION OF THE FIGURES

In the figures,

FIG. 1 is a schematic diagram of a 2×2 Multi-Transverse-Mode Optical Processor (MTMOP) building block, in accordance with an illustrative embodiment;

FIG. 2 is a schematic diagram of a 4×4 MTMOP using a plurality of the 2×2 MTMOP building blocks of FIG. 1A, in accordance with an illustrative embodiment;

FIG. 3 is a flowchart of a method for programming the MTMOP of FIG. 2, in accordance with an illustrative embodiment;

FIG. 4 is a block diagram of an example computing device, in accordance with an illustrative embodiment;

FIG. 5 is a plot illustrating changes in effective indices with temperature as a function of phase shifter width for optical modes TE0 and TE1, in accordance with an illustrative embodiment;

FIG. 6A is a plot illustrating a TE0 phase shift applied by external phase shifters, in accordance with an illustrative embodiment;

FIG. 6B is a plot illustrating a TE1 phase shift applied by external phase shifters, in accordance with an illustrative embodiment;

FIG. 6C is a plot illustrating the output power of TE0 and TE1 at output port O₀ and phase shift applied to TE0 as a function of phase shifter voltage bias, in accordance with an illustrative embodiment;

FIG. 7A is a plot illustrating the output power of TE1 at O₀ versus the phase shift applied for different values of mode sensitivity, in accordance with an illustrative embodiment; and

FIG. 7B is a plot illustrating the TE1 extinction ratio versus mode sensitivity, in accordance with an illustrative embodiment.

It will be noticed that throughout the appended drawings, like features are identified by like reference numerals.

### DETAILED DESCRIPTION

Described herein is a Multi-Transverse-Mode Optical Processor (MTMOP) that exploits multiple quasi-transverse electric (TE) optical modes, namely the fundamental TE mode (TE0) and the first TE mode (TE1), in an optical computation platform. The proposed MTMOP may be used for large-scale optical computing applications. In one embodiment, the MTMOP may be used to measure the optical phase shift required for programming the optical processor, without the use of conventional optical phase detection techniques such as coherent detection. In the proposed MTMOP design, a building block (also referred to herein as an “optical processing unit”) that converts the optical phase to optical power is used. Mode TE0 carries the main optical signal while mode TE1 is used for purposes of programming the MTMOP. Operation of the proposed MTMOP relies on the fact that the group velocity of TE0 and TE1 propagating through a mode-sensitive phase shifter is different. As will be discussed further below, the proposed MTMOP comprises an unbalanced Mach-Zehnder interferometer (MZI) comprising a mode-sensitive phase shifter in a first optical waveguide arm and a mode-insensitive phase shifter in a second optical waveguide arm. The direct current (DC) voltage bias of each phase shifter is set so that the TE0 modes propagating in the two waveguide arms constructively interfere while the TE1 modes propagating in the two waveguide arms do not constructively interfere. Hence, the phase shift applied to the TE0 mode can be detected by measuring the variation in the optical power of the TE1 mode.

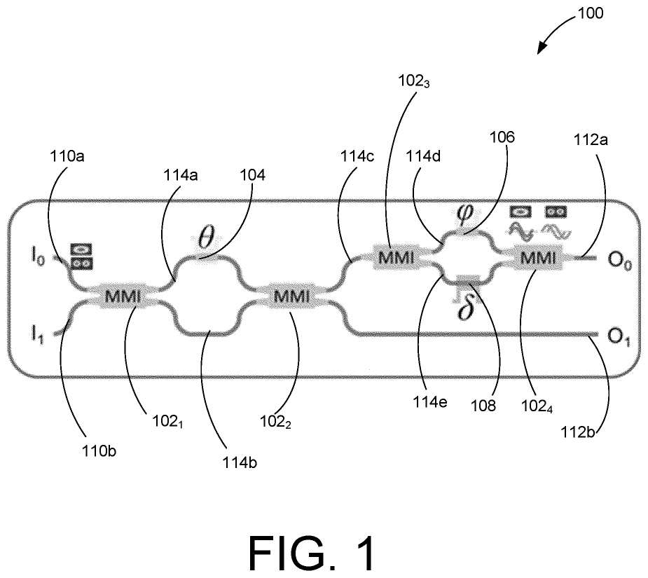

Referring now to FIG. 1, an example 2×2 MTMOP building block 100 will now be described, in accordance with one embodiment. The building block (or optical processing unit) relies on propagation of two orthogonal TE optical modes: the fundamental TE mode (TE0) that carries the main optical signal, and the first TE mode (TE1) for performing phase calibration. In the illustrated embodiment, the building block 100 comprises four (4) multimode interferometers (MMI) 102₁, 102₂, 102₃, and 102₄, an internal phase shifter 104 having an internal phase shift θ (which has the same value for TE0 and TE1), a first external phase shifter 106 having an external phase shift Φ (which has the same value for TE0 and TE1), and a second external phase shifter 108 having an external phase shift δ (which has a first value for TE0 and a second value for TE1). In one embodiment, the phase shifts θ, Φ, and δ have different values. In other embodiments, the building block 100 may comprise four (4) multimode directional couplers rather than four (4) MMIs. It should be understood that any other optical device (referred to herein as a “beam splitter”) configured to split an optical wave (e.g., using a 50:50 splitting ratio), or any other optical device (referred to herein as a “beam 220 combiner”) configured to combine an optical wave, may apply. For example, in some embodiments, y-junctions may be used. Other embodiments may apply.

As will be described further below, the building block 100 comprises two interconnected reconfigurable MZIs, the first MZI (formed by the interconnection of MMIs 102₁ and 102₂) comprising a mode-insensitive phase shifter in one optical waveguide arm, and the second MZI (formed by the interconnection of MMIs 102₃ and 102₄) comprising a mode-sensitive phase shifter in a first optical waveguide arm and a mode-insensitive phase shifter in a second optical waveguide arm. In one embodiment, each phase shifter 104, 106, 108 is a thermo-optic phase shifter that operates by heating a waveguide of the MZI to change the waveguide's refractive index. It should however be understood that any other suitable phase shifter including, but not limited to, an electro-optic phase shifter that operates by applying an electric field or electrical current to change the waveguide's refractive index, may apply.

The first MMI 102₁ is coupled to input waveguide arms 110a, 110b for receiving an input optical wave, provided as an optical input vector [I₀ I₁] of input optical signals, while the last MMI 102₄ is coupled to output waveguide arms 112a, 112b for outputting an output optical wave, provided as an optical output vector [O₀ O₁] of output optical signals. In one embodiment, the MMIs 102₁, 102₂, 102₃, 102₄ are mode insensitive couplers (e.g., multimode directional couplers). As used herein, the term “mode insensitive”, as opposed to the term “mode sensitive”, refers to the fact that a given device (e.g., an MMI, a directional coupler or a phase shifter) is insensitive to the TE mode propagating through the waveguide arm the device is provided on. For instance, a mode insensitive coupler applies a same splitting ratio to different TE modes and a mode insensitive phase shifter applies a same phase shift to different TE modes such that both TE0 and TE1 modes travel through the phase shifter with the same speed. In contrast, the term “mode sensitive” refers to the fact that a given device (e.g., a phase shifter) is sensitive to the TE mode propagating through the waveguide arm the device is provided on. For instance, a mode sensitive phase shifter applies different phase shifts to different TE modes such that the group velocity of TE0 and TE1 modes propagating through the phase shifter is different. It will be appreciated that the terms “interconnected”, “coupled”, “optically coupled” and “connected”, as used herein, imply that an optical connection is made between components such that an optical wave is able to propagate. The terms “interconnected” and “connected” may imply both direct coupling (in which two elements that are coupled to each other contact each other) and indirect coupling (in which at least one additional element is located between the two elements).

In one embodiment, each MMI 102₁, 102₃ behaves as a beam splitter (e.g., a beam splitter with a 50:50 splitting ratio) and each MMI 102₂, 102₄ behaves as a beam combiner. In particular, an optical wave, also referred to as an input optical wave, (i.e. the input vector [I₀ I₁] of optical signals) is guided by the input waveguide arms 110a, 110b and enters the MMI 102₁ where the optical wave is split into two optical waves that exit the MMI 102₁ along two internal waveguide arms 114a, 114b. The internal waveguide arm 114a comprises the phase shifter 104, which is configured to control the power provided at the output waveguide arms 112a, 112b. The optical waves guided by the two internal waveguide arms 114a, 114b enter the MMI 102₂ where they are combined and two optical waves are generated. The optical waves exit the MMI 102₂ along an internal waveguide arm 114c and the output waveguide arm 112b. The optical wave guided by the internal arm 114c enters the MMI 102₃ where it is split into two optical waves. The optical waves exit the MMI 102₃ along internal arms 114d, 114e, with the power in each arm 114d, 114e being half the power in arm 114c. The internal waveguide arm 114d comprises the first external phase shifter 106 and the internal waveguide arm 114e comprises the second external phase shifter 108. The external phase shifters 106, 108 are used for determining the relative phase of the output provided at the output waveguide arms 112a, 112b. Optical waves exit the phase shifters 106, 108 along waveguide arms 114d, 114e, respectively, and enter the MMI 102₄, where the optical waves are combined. An optical wave, also referred to as an output optical wave having a given amplitude and phase, then exits the MMI 102₄ along output waveguide arm 112a, with the power in the waveguide arm 112a being double the power in waveguide arms 114d, 114e. The output vector [O₀ O₁] of optical signals is thus provided at output arms 112a, 112b.

The power levels and the relative phase of the optical wave provided at the output waveguide arms 112a, 112b are controlled by applying required DC bias voltages to the internal and external phase shifters 104, 106, 108 for adjustment thereof. In particular, the internal and external phase shifters 104, 106, 108 have independent phase shifts (θ, Φ, δ) to control different parameters of the MTMOP building block 100. The internal phase shift (θ) of the internal phase shifter 104 can be adjusted to control (i.e. defines) the amplitude of the optical power provided at the output waveguide arms 112a, 112b, i.e. to change the output optical intensity. The external phase shifts (Φ, δ) of the external phase shifters 106, 108 define the relative phase of the optical power provided at the waveguide output arms 112a, 112b. In other words, the amplitude and phase of the optical power provided at the waveguide output 285 arms 112a, 112b can be controlled and adjusted to any level of interest by tuning the phase shifts of the phase shifters 104, 106, 108.

It is proposed herein for the internal phase shifter 104 and the first external phase shifter 106 to be mode insensitive phase shifters that apply the same phase shift to the TE0 and TE1 modes. The second external phase shifter 108 is a mode sensitive phase shifter that applies different phase shifts to the TE0 and TE1 modes. In one embodiment, the second external phase shifter 108 has different thermo-optic coefficients (dn_{eff}/dT) for TE0 and TE1, where n_{eff} is the effective refractive index and T is the temperature. Thus, optical mode TE0 constructively interferes through phase shifters 106 and 108 while optical mode TE1 does not. Phase changes experienced by TE0 are measured through changes in the TE1 optical power.

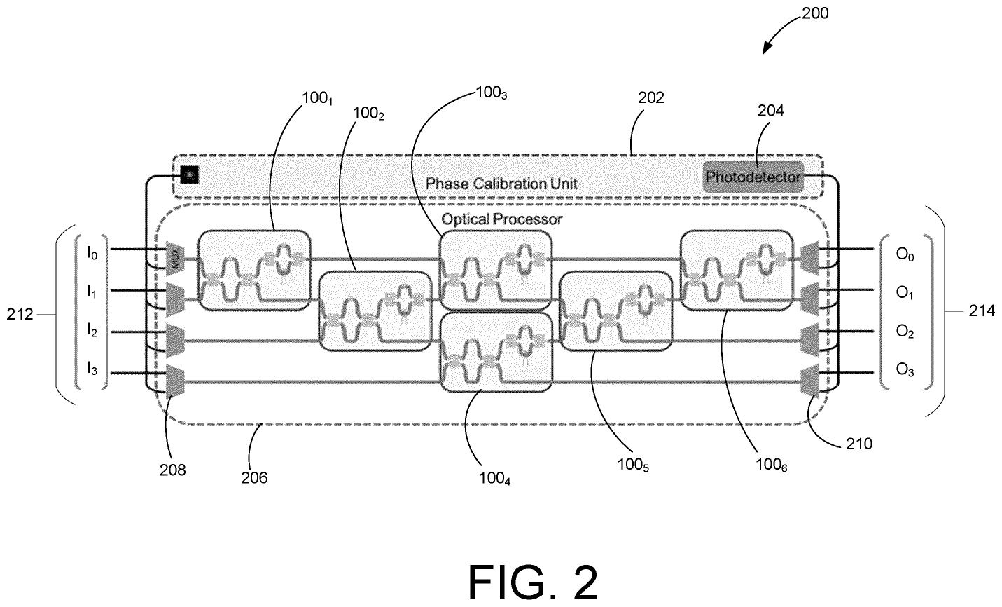

Referring now to FIG. 2, an example 4×4 MTMOP 200 will now be described, in accordance with one embodiment. The MTMOP 200 is based on the MTMOP building block described above with reference to FIG. 2. The MTMOP 200 comprises a phase calibration unit 202 comprising a photodetector 204, and an optical processor comprising a plurality of interconnected MTMOP building blocks 100₁, 100₂, 100₃, 100₄, 100₅, 100₆. The phase calibration unit 202 is used to tune (i.e. apply required DC bias voltages to) the phase shifters (references 104, 106, 108 in FIG. 1) forming the MTMOP building blocks 100₁, 100₂, 100₃, 100₄, 100₅, 100₆, while the photodetector 204 is used to measure the output power of the optical processor 206. The MTMOP 200 further comprises a plurality of multiplexers 208 and a plurality of de-multiplexers 210. Each multiplexer 208 interconnects input ports 212 of the MTMOP 200 to an input waveguide arm of a MTMOP building block 100₁, 100₂, 100₄. Each de-multiplexer 210 interconnects an output waveguide arm of a MTMOP building block 100₄, 100₅, 100₆ to output ports 214 of the MTMOP 200. An array of input optical waveguides is therefore provided at an input of the optical processor 206 and an array of output optical waveguides is provided at an output of the optical processor 206. As can be seen in FIG. 1, each one of the MTMOP building blocks 100₂, 100₃, 100₄, 100₅ has its input waveguide arms connected to the output waveguide arms of another one of the MTMOP building blocks 100₁, 100₂, 100₃, 100₄, and its output waveguide arms connected to the input waveguide arms of another one of the MTMOP building blocks 100₃, 100₄, 100₅, 100₆.

The MTMOP 200 illustrated in FIG. 2 is designed on a 4×4 Reck mesh such that six (6) MTMOP building blocks 100₁, 100₂, 100₃, 100₄, 100₅, 100₆, four (4) multiplexers 208, and four (4) de-multiplexers 210 are provided. It should however be understood that this is for illustrative purposes only and that any other suitable programmable optical processor architecture including, but not limited, Clement mesh and diamond mesh, may apply. As such, the MTMOP 200 may comprise any suitable number of components (i.e., MTMOP building blocks, multiplexers, and de-multiplexers). In addition, while a 4×4 MTMOP 200 is illustrated and described herein, a larger optical processor structure may be achieved using additional building blocks (reference 100 in FIG. 1). In some embodiments, several 4×4 MTMOPs 200 may be cascaded with one another to achieve an optical processor structure of desired dimension N (with N greater than 4).

In one embodiment, the phase calibration unit 202 is configured to generate an optical signal that is mode multiplexed (using the multiplexers 208) with a main optical input vector of optical signals (labelled [I₀ I₁ I₂ I₃] in FIG. 2) provided at the input ports 212 (i.e. at the array of input waveguides) and the resulting optical signals are guided by the input waveguide arms of the MTMOP building blocks 100₁, 100₂, 100₄. In particular, for each MTMOP building block 100₁, 100₂, 100₄, an optical signal is applied on TE1 and TE0. At the output of the optical processor 206, the two modes TE1 and TE0 are de-multiplexed (using the de-multiplexers 210), with the TE0 mode being provided at the output ports 214 and the TE1 mode being detected by the phase calibration unit 202, for programming purposes. An optical output vector of output optical signals (labelled [O₀ O₁ O₂ O₃] in FIG. 2) is then provided at the output ports 214.

In one embodiment, the MTMOP 200 may be fabricated on a silicon-on-insulator (SOI) chip with a device thickness of 220 nm. In this embodiment, the width of the waveguides for single mode propagation (TE0) and multi-mode propagation (TE0 and TE1) are 0.43 μm and 0.96 μm, respectively. Adiabatic directional coupler-based mode multiplexers as in 208 and de-multiplexers as in 210 are illustratively used for mode conversion at the input and output of the MTMOP 200, as described herein above. In one embodiment, the phase shifters 104, 106, 108 are thermo-optic phase shifters realized using high-resistance titanium-tungsten alloy (TiW). Contact with the heaters of the phase shifters may be made using a low-resistance titanium-tungsten/aluminum bi-layer (TiW/AI).

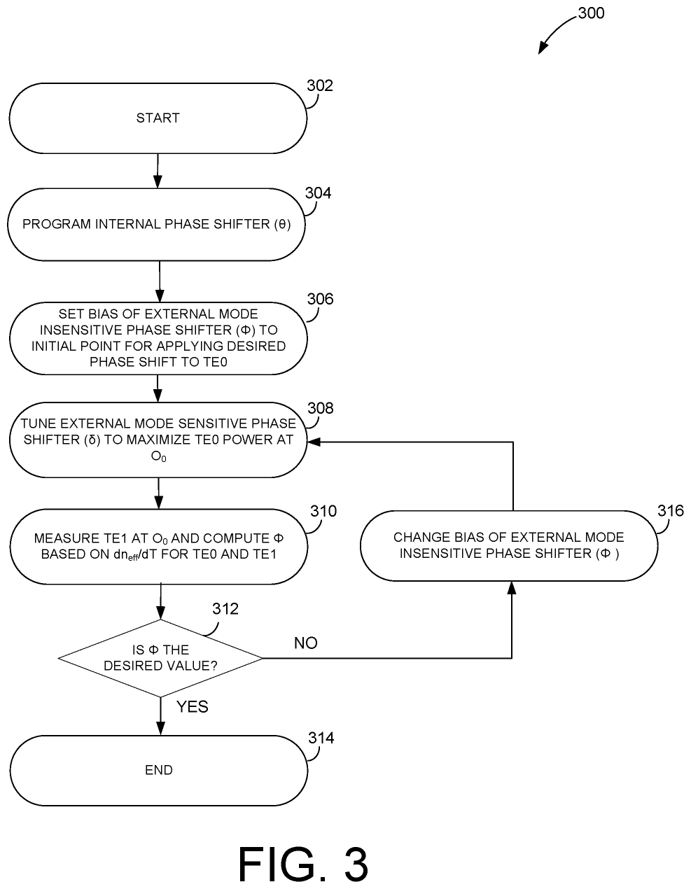

FIG. 3 illustrates an example flowchart of a method 300 for programming the MTMOP (reference 200 in FIG. 2). The method 300 is illustratively performed using the phase calibration unit 202. Following the start 302 of the method 300, for each MTMOP building block, the internal phase shifter (reference 104 in FIG. 1) having the internal phase shift θ is first calibrated and programmed at step 304, in order to define the MTMOP's output optical power. In one embodiment, step 304 comprises applying an electrical DC voltage (e.g., via electrical DC pads) to achieve a desired power level at the MTMOP output. The value of the DC voltage may be determined through simulation of the internal phase shifter. In one embodiment, step 304 comprises sweeping (i.e. applying) DC voltage bias values for the internal phase shifter and measuring the TE0 optical power at an output of the MTMOP to determine whether the desired power level has been achieved. In the illustrated embodiment, the TE0 optical power is measured at an upper (or top) one (labelled O₀ in FIGS. 1 and 2) of the output ports (reference 112 in FIG. 1). Considering the 50:50 splitting ratio of the splitter/combiner MMIs (references 102₁, 102₂, 102₃, 102₄ in FIG. 1), the optical power is minimized at θ=0 and maximized at θ=π, for all values of ϕ and δ. For each internal phase shifter to be calibrated, step 304 may therefore comprise selecting a path including the corresponding MTMOP building block, setting the remaining MTMOP building blocks to minimum or maximum transmission (i.e. setting the phase shift θ of the remaining internal phase shifters to 0 or π), and measuring the optical intensity at the output of the MTMOP subsequent to application of a given value of the DC voltage bias. In some embodiments, a correlation between DC bias voltage value(s), the corresponding internal phase shift θ value(s), and the corresponding optical power level(s) output by the MTMOP 200 (in response to the DC bias voltage values being applied) may be stored (in any suitable format, including, but not limited to, a lookup table) in memory or other suitable storage for subsequent retrieval for calibrating the internal phase shifter at step 304 (e.g., at step 304).

To calibrate and program the external phase shifters, the next step 306 is to set, for each MTMOP building block, a DC voltage bias of the external mode insensitive phase shifter (reference 106 in FIG. 1) as an initial point (or value) for the desired TE0 phase shift. At step 308, the external mode sensitive phase shifter (reference 108 in FIG. 1) is then tuned to maximize the TE0 power output at output port O₀. For this purpose, voltage bias values for the external mode sensitive phase shifter are swept until a voltage bias value that maximizes the TE0 signal power at O₀ is determined, meaning that the TE0 signal passing through the phase shifters 106, 108 constructively interferes. This would not be the case for TE1 owing to the mode sensitive nature of the external phase shifter 108. At step 310, TE1 is measured at O₀ and the phase shift (ϕ) applied to the TE0 optical mode is computed knowing dn_{eff}/dT for TE0 and TE1. The phase shift (ϕ) is computed at step 310 by measuring the output amplitude of TE1. Knowing the phase shift (ϕ) applied to TE0, the process is iterated until the desired phase shift to TE0 is achieved. For this purpose, the next step 312 is to assess whether the value of the phase shift (ϕ) is the desired value. If this is the case, the method 300 ends at step 314. Otherwise, the bias of the external mode insensitive phase shifter is changed at step 316 and the method 300 returns to step 308.

Using the process described above with reference to FIG. 3, the phase shift applied by the external phase shifter 106 can be monitored, which may be helpful in both the calibration and programming phases of optical processors. In some embodiments, the MTMOP 200 may be calibrated completely on-chip, without the need for coherent detection. Moreover, in some embodiments, in the programming phase, the MTMOP 200 enables monitoring of the phase shift applied by the external mode insensitive phase shifter 106, resulting in a feedback signal being provided. This feedback signal can be used for closed loop programming and may allow to compensate for dynamic errors, resulting in more accurate performance.

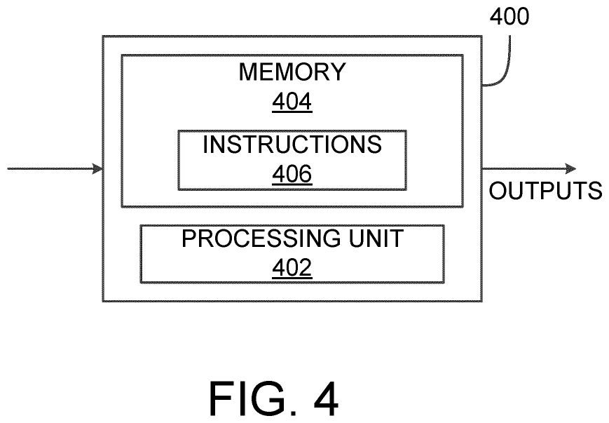

FIG. 4 is a schematic diagram of computing device 400, which may be used to implement the method 300 of FIG. 3. The computing device comprises a processing unit 402 and a memory 404 which has stored therein computer-executable instructions 406. The processing unit may 402 may comprise any suitable devices configured to implement the functionality of the method 300 such that instructions 406, when executed by the computing device 400 or other programmable apparatus, may cause the functions/acts/steps performed by method 300 as described herein to be executed. The processing unit 402 may comprise, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory 404 may comprise any suitable known or other machine-readable storage medium. The memory 404 may comprise non-transitory computer readable storage medium, for example, but not limited to, an electronic, magnetic, optical, electromagnetic, infrared, or semiconductor system, apparatus, or device, or any suitable combination of the foregoing. The memory 404 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 404 may comprise any storage means (e.g. devices) suitable for retrievably storing machine-readable instructions 406 executable by the processing unit 402.

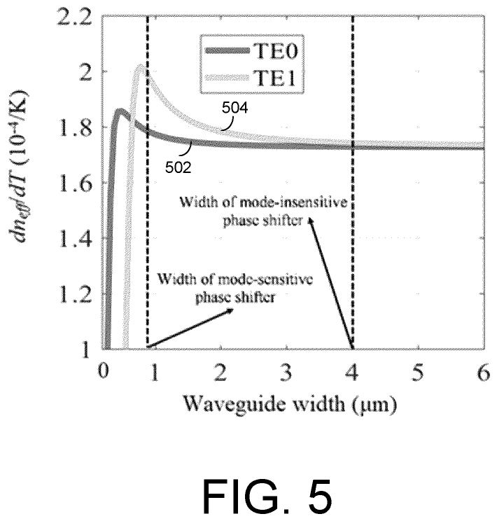

As shown in FIG. 5, in one embodiment, the design of the external phase shifters 106, 108 is done using numerical tools, by simulating the thermo-optic coefficient (dn_{eff}/dT) for different TE modes as a function of the phase shifter's width. In particular, FIG. 5 illustrates changes in thermo-optic coefficient (dn_{eff}/dT) as a function of phase shifter width for the first two TE modes. The plot 502 illustrates the thermo-optic coefficient (dn_{eff}/dT) as a function of waveguide width for the TE0 mode while the plot 504 illustrates the thermo-optic coefficient (dn_{eff}/dT) as a function of waveguide width for the TE1 mode. In the illustrated example, it can be seen that, for a waveguide width larger than 4 μm, the difference between the values of the thermo-optic coefficient for TE0 and TE1 is less than 1% and the phase shifter is thus mode insensitive. For a phase shifter having a width smaller than 4 μm, the thermo-optic coefficient varies for TE0 and TE1, resulting in a mode sensitive phase shifter. If the phase shifter width is further decreased below 0.96 μm, the propagation loss of TE1 drastically increases due to the overlap of its field distribution and the waveguide sidewalls. In the illustrated embodiment, the width of 4 μm is selected for the mode insensitive phase shifters 104, 106 (having respective phase shifts θ and ϕ) with dn_{eff}/dT=1.74 for both TE0 and TE1. As can be seen from the plots 502 and 504, while further increase in the width of the mode insensitive phase shifter does not contribute considerably to phase insensitivity, it decreases power efficiency. In the illustrated embodiment, a width of 0.96 μm is selected for the mode sensitive phase shifter 108 (having phase shift δ) to maximize the phase sensitivity while maintaining low propagation loss for TE1 mode. In this embodiment, for the phase shifter 108, dn_{eff}/dT is 1.8 and 1.96 for TE0 and TE1, respectively.

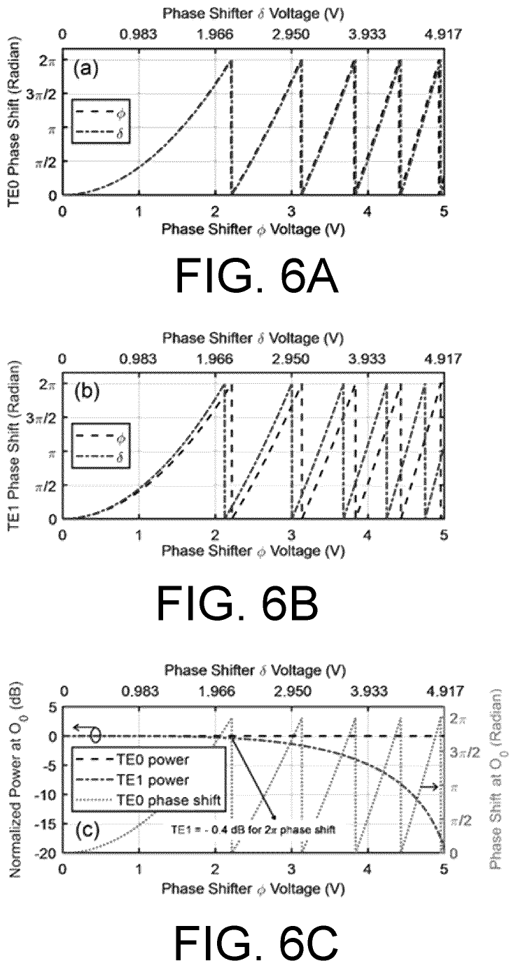

FIG. 6A plots the simulated TE0 phase shift passing through the external phase shifters (having phase shifts ϕ and δ). As indicated in the flowchart of FIG. 3, the bias of the two external phase shifters is selected to maintain constructive interference for TE0 at output port O₀. The x-axis of all plots in FIGS. 6A, 6B, and 6C is scaled to highlight this choice of bias for the two external phase shifters. FIG. 6B plots the simulated TE1 phase shift applied by the external phase shifters. The first external phase shifter (having phase shift ϕ) applies the same phase shift to the TE0 and TE1 modes due to its mode-insensitive characteristics. However, the second external phase shifter (having phase shift δ) is mode sensitive and imparts a different phase shift to TE1. FIG. 6A displays the manner in which the optical signals passing through the two external phase shifters constructively interfere for TE0, while this is not the case for TE1, as shown in FIG. 6B. FIG. 6C plots the simulated TE0 output power (dashed line), TE0 output phase (dotted line), and TE1 output power (dash-dotted line) at O₀ versus the phase shifter bias voltages. The TE0 and TE1 output powers are normalized to their maximum value. While the optical output power of the TE0 mode remains constant, its output phase changes with the phase shift ϕ. By monitoring the optical power change of TE1, the phase of TE0 can be inferred and the phase shift applied to TE0 can therefore be properly measured without the need for a coherent photodetection scheme. For example, if the TE1 power is −1.67 dB less from its maximum value, the corresponding phase shift of TE0 is 4π with a ϕ bias of 3.1 V (see FIG. 6C).

To achieve precise measurement of phase, a small change in the phase shift ϕ should lead to a detectable change in the TE1 power. The TE1 extinction ratio (ERTE1) is defined as the ratio of the TE1 optical power while the phase ϕ changes by 2π. As shown in FIG. 6C, for ϕ between 0 and 2π, ERTE1 is around 0.4 dB (Normalized TE1 is 0 dB for ϕ=0 and −0.4 dB for ϕ=2π). To increase ERTE1, the first external phase shifter (having phase shift ϕ) can be biased at larger values of voltage, for example between 2.2V and 3.1V to get a phase shift of 2π to 4π. However, this approach leads to additional power consumption.

As proposed herein, although the second external phase shifter (having phase shift δ) is mode sensitive, the thermo-optic coefficient (dn_{eff}/dT) of this phase shifter is close in value for TE0 and TE1 (1.8 and 1.96, respectively, from FIG. 5), leading to an ERTE1 that is relatively small in the proposed MTMOP design. In one embodiment, a conventional narrow waveguide may be used for the mode sensitive phase shifter. Design of a more complex mode sensitive phase shifter with a larger difference in the thermo-optic coefficient (dn_{eff}/dT) of the optical modes would lead to a higher ERTE1, and, thus, more dynamic range phase programmability. Mode sensitivity (ζ) for a phase shifter is defined as the ratio of dn_{eff}/dT for TE1 and TE0, as follows:

$$ζ = \frac{{dn}_{eff} ( TE 1 ) / dT}{{dn}_{eff} ( TE 0 ) / dT} \qquad ( 1 )$$

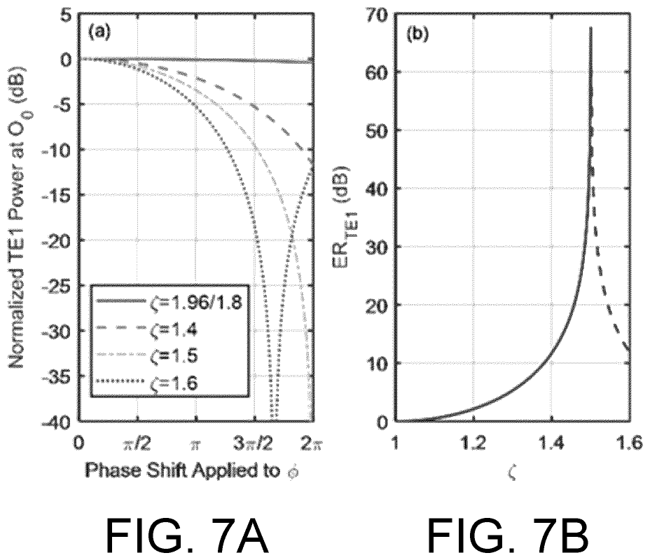

FIG. 7A shows the normalized TE1 optical power at O₀ versus the phase shift applied to TE0 for different values of ζ. Following the procedure presented in the flowchart of FIG. 3, constructive interference at O₀ is maintained for TE0 by selecting an appropriate bias applied to δ. As shown in FIG. 7A, increasing ζ from 1.09 (1.96/1.8) to 1.5 leads to a larger change in the detected TE1 power while sweeping ϕ from 0 to 2π, thus resulting in larger ERTE1. In one embodiment, a mode sensitive phase shifter with ζ close to 1.5 can be realized using inverse design and may contribute to an optimized MTMOP performance. As illustrated in FIG. 7A, for ζ=1.5, ERTE1 is maximized. In this case, for a 2π phase shift applied to TE0 (i.e., 2π accumulation for TE0 from both ϕ and δ), the phase shift applied to TE1 is 2π in the first external, mode insensitive, phase shifter (ϕ) arm and 3π in the second external, mode sensitive, phase shifter (δ) arm, leading to destructive interference for TE1. Therefore, the TE1 power at O₀ is minimum. For ζ>1.5, TE1 optical power would not be an injective (one-to-one) function of the phase shift applied to TE0 over 0<ϕ<2π meaning that, for a single value of TE1 power, one can read two values of phase shift. Thus, it is desirable to keep ζ≤1.5 to estimate ϕ from TE1 optical power without requiring further analysis. FIG. 7B shows the calculated ERTE1 versus ζ of the phase shifter δ. In FIG. 7B, ζ>1.5 is shown with a dash line to highlight the injective function part.

As previously noted, the optical processor proposed herein can be programmed for a given application by adjusting the phase shifters in the structure. It is worth noting that, compared to the conventional optical processors, the proposed MTMOP 2×2 building block includes an additional MZI (formed by the interconnection of MMIs 102₃, 102₄) leading to a higher insertion loss. Also, the proposed MTMOP uses multimode components (MMIs, waveguide bends, crossings, etc.) exhibiting more insertion loss compared to single mode structure counterparts. Considering the developing trend in SiPh multi-mode components to be used in mode-division-multiplexing (MDM) telecommunication systems, MTMOP, such as the one proposed herein, provides a viable solution to advance towards scalable self-programming optical processors.

In terms of power consumption, the proposed MTMOP includes an additional phase shifter per 2×2 building block, compared to conventional optical processors. In one embodiment, while this may lead to an average increase of 50% power dissipation in the phase shifters, the MTMOP design described herein provides a solution for on-chip monitoring of optical phase. This in turn reduces the complexity and elaboration of power-hungry hardware used for detecting optical phase and simplifies the optimization algorithms used for programming the optical processors.

In some embodiments, compared to conventional technologies, the proposed MTMOP may provide an accurate, low-cost, and fast programming procedure capable of being integrated with SiPh. In a conventional programmable optical processor, one needs a coherent detector to measure the optical phase of phase shifters to program the processor. Integrating a coherent detector in a SiPh chip increases the cost, area, power consumption, and complexity of the optical processor design. In one embodiment, the proposed MTMOP design may allow to overcome this challenge by introducing a building block that enables optical phase measurement without the need for coherent detection. Using orthogonal TE optical modes, the MTMOP converts the optical phase into optical intensity that can then be measured on chip using optical photodetectors widely available in process design kit (PDK) of SiPh microfabrication foundries. In this manner, direct programmability may be achieved.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. An optical processing unit comprising:
a first Mach-Zehnder interferometer (MZI) and a second MZI optically coupled to the first MZI, each of the first MZI and the second MZI having a first internal waveguide arm and a second internal waveguide arm configured to propagate optical modes therein;
a first phase shifter optically coupled to the first internal waveguide arm of the first MZI and configured to impart a same first phase shift to the optical modes;
a second phase shifter optically coupled to the first internal waveguide arm of the second MZI and configured to impart a same second phase shift to the optical modes; and
a third phase shifter optically coupled to the second internal waveguide arm of the second MZI and configured to impart a third phase shift to the optical modes, the third phase shift having a different value for each of the optical modes.

2. The optical processing unit of claim 1, wherein the optical modes comprise a fundamental quasi-transverse electric (TE0) mode and a first quasi-transverse electric (TE1) mode.

3. The optical processing unit of claim 1, wherein the first MZI has a first input waveguide arm optically coupled to a first input port and a second input waveguide arm optically coupled to a second input port, and further wherein a first optical wave having the optical modes is received via the first input port and the second input port.

4. The optical processing unit of claim 3, wherein the first MZI has a first output waveguide arm and a second output waveguide arm, and further wherein the second MZI has a third input waveguide arm and a third output waveguide arm, the first output waveguide arm of the first MZI optically coupled to the third input waveguide arm of the second MZI, the second output waveguide arm of the first MZI optically coupled to a first output port, and the third output waveguide arm of the second MZI optically coupled to a second output port.

5. The optical processing unit of claim 4, wherein the first MZI comprises:
a first beam splitter configured to split the first optical wave into second optical waves guided by the first internal waveguide arm and the second internal waveguide arm of the first MZI; and
a first beam combiner configured to combine the second optical waves into third optical waves guided by the first output waveguide arm and the second output waveguide arm of the first MZI.

6. The optical processing unit of claim 5, wherein the second MZI comprises:
a second beam splitter configured to split one of the third optical waves guided by the first output waveguide arm into fourth optical waves guided by the first internal waveguide arm and the second internal waveguide arm of the second MZI; and
a second beam combiner configured to combine the fourth optical waves from the first internal waveguide arm and the second internal waveguide arm of the second MZI into a fifth optical wave guided by the output waveguide arm of the second MZI.

7. The optical processing unit of claim 6, wherein each of the first beam splitter, the first beam combiner, the second beam splitter, and the second beam combiner is a multimode interferometer (MMI).

8. The optical processing unit of claim 6, wherein each of the first beam splitter, the first beam combiner, the second beam splitter, and the second beam combiner is a directional coupler.

9. The optical processing unit of claim 4, wherein output optical power having an amplitude and a phase is output via the first output port and the second output port, and further wherein the first phase shifter is configured to impart the first phase shift for controlling the amplitude of the optical power and the second phase shifter and the third phase shifter are respectively configured to impart the second phase shift and the third phase shift for controlling the phase of the optical power.

10. The optical processing unit of claim 1, wherein each of the first phase shifter, the second phase shifter, and the third phase shifter is a thermo-optic phase shifter having a thermo-optic coefficient, and further wherein the thermo-optic coefficient of the first phase shifter and the second phase shifter is the same for all the optical modes, and the thermo-optic coefficient of the third phase shifter is different for each of the optical modes.

11. An optical processor system comprising:
an array of input optical waveguides configured to receive an optical input vector comprising a first plurality of optical signals;
an array of output optical waveguides; and
a multi-transverse-mode optical processor interposed between the array of input optical waveguides and the array of output optical waveguides and in optical communication therewith for guiding the first plurality of optical signals towards the array of output optical waveguides, the optical processor comprising a plurality of interconnected optical processor building blocks, each optical processor building block comprising:
a first Mach-Zehnder interferometer (MZI) and a second MZI optically coupled to the first MZI, each of the first MZI and the second MZI having a first internal waveguide arm and a second internal waveguide arm and configured to propagate optical modes therein;
a first phase shifter optically coupled to the first internal waveguide arm of the first MZI and configured to impart a same first phase shift to the optical modes;
a second phase shifter optically coupled to the first internal waveguide arm of the second MZI and configured to impart a same second phase shift to the optical modes; and
a third phase shifter optically coupled to the second internal waveguide arm of the second MZI and configured to impart a third phase shift to the optical modes, the third phase shift having a different value for each of the optical modes.

12. The optical processor system of claim 11, wherein the optical modes comprise a fundamental quasi-transverse electric (TE0) mode and a first quasi-transverse electric (TE1) mode.

13. The optical processor system of claim 11, further comprising a phase calibration unit configured to apply a first bias voltage to the first phase shifter for causing the first phase shifter to impart the first phase shift to the optical modes, a second bias voltage to the second phase shifter for causing the second phase shifter to impart the second phase shift to the optical modes, and a third bias voltage to the third phase shifter for causing the third phase shifter to impart the third phase shift to the optical modes.

14. The optical processor system of claim 11, further comprising a plurality of multiplexers each interconnecting input ports of the optical processor system to input waveguide arms of first selected ones of the plurality of interconnected optical processing units, and a plurality of de-multiplexers each interconnecting output ports of the optical processor system to output waveguide arms of second selected ones of the plurality of interconnected optical processing units.

15. The optical processor system of claim 13, wherein the phase calibration unit is configured to, for each of the plurality of interconnected optical processor building blocks:
(a) apply an electrical voltage to the first phase shifter to achieve a desired power level at an output of the optical processor;
(b) set a voltage bias value of the second phase shifter to an initial value;
(c) determine the voltage bias value of the third phase shifter that maximizes a TE0 power output at a first one of the output optical waveguides;
(d) measure a TE1 power output at the first output optical waveguide and compute a given phase shift for the second phase shifter based on a thermo-optic coefficient for TE0 and TE1;
(e) compare the computed phase shift to a desired phase shift value; and
(f) determine that the computed phase shift fails to match the desired phase shift value, change the voltage bias value of the second phase shifter, and repeat steps (c) to (e).

16. The optical processor system of claim 11, wherein, for each optical processor building block, the first MZI has a first input waveguide arm optically coupled to a first input port and a second input waveguide arm optically coupled to a second input port, and further wherein a first optical wave having the optical modes is received via the first input port and the second input port.

17. The optical processor system of claim 16, wherein, for each optical processor building block, the first MZI has a first output waveguide arm and a second output waveguide arm, and further wherein the second MZI has a third input waveguide arm and a third output waveguide arm, the first output waveguide arm of the first MZI optically coupled to the third input waveguide arm of the second MZI, the second output waveguide arm of the first MZI optically coupled to a first output port, and the third output waveguide arm of the second MZI optically coupled to a second output port.

18. A method for programming a multi-transverse-mode optical processor, the optical processor interposed between a plurality of input optical waveguides and a plurality of output optical waveguides, the method comprising:
(a) applying an electrical voltage to a first phase shifter of the optical processor to achieve a desired power level at an output of the optical processor;
(b) setting a voltage bias value of a second phase shifter of the optical processor to an initial value, the second phase shifter configured to impart a same phase shift to different optical modes propagating through the optical processor;
(c) determining the voltage bias value of a third phase shifter of the optical processor that maximizes a TE0 power output at a first one of the output optical waveguides, the third phase shifter configured to impart different phase shifts to the different optical modes propagating through the optical processor;
(d) measuring a TE1 power output at the first output optical waveguide and compute a given phase shift for the second phase shifter based on a thermo-optic coefficient for TE0 and TE1;
(e) comparing the computed phase shift to a desired phase shift value; and
(f) determining that the computed phase shift fails to match the desired phase shift value, changing the voltage bias value of the second phase shifter, and repeating steps (c) to (e).

19. The method of claim 18, wherein applying the electrical voltage to a first phase shifter comprises applying a plurality of Direct Current (DC) bias voltage values and measuring the TE0 power output at the first one of the output optical waveguides to determine whether the desired power level at the output of the optical processor has been achieved.

20. The method of claim 18, further comprising (g) storing a correlation between the DC bias voltage values, respective values of a first phase shift imparted by the first phase shifter upon application of the respective DC bias voltage values, and respective power levels output by the optical processor in response to application of the respective DC bias voltage values.
